(19) United States
(12) Patent Application Publication
(10) Pub. No.: US 2024/0181950 A1
(43) Pub. Date: Jun. 6, 2024

(54) SINGLE-SIDED MOVABLE BATTERY SWAP STATION

(71) Applicant: VOLTA AUTO INC., Vancouver (CA)

(72) Inventor: Changqing YU, Vancouver (CA)

(73) Assignee: VOLTA AUTO INC., Vancouver (CA)

(21) Appl. No.: 18/393,577

(22) Filed: Dec. 21, 2023

(30) Foreign Application Priority Data
Dec. 2, 2022 (CA) 3183328

(51) Int. Cl. B60P 1/64; B60L 53/80; B60S 9/02

(52) U.S. Cl. CPC B60P 1/6436; B60L 53/80; B60P 1/6481; B60P 1/649; B60S 9/02

(57) ABSTRACT

The present disclosure discloses a single-sided movable battery swap station. Wheels are mounted on a chassis; an equipment compartment is fixed above the chassis and is provided with batteries therein; and a sliding part is slidably connected to the equipment compartment, a first speed reducer is fixed with the sliding part and an output shaft thereof is sleeved and fixedly provided with a gear engaged with a rack in the equipment compartment, a first telescopic cylinder is respectively fixed with the sliding part and a second speed reducer of which an output shaft is fixed with a clamping part via a transverse telescopic part, and the clamping part is detachably connected to the batteries.

### CROSS-REFERENCE TO RELATED APPLICATIONS

The application claims priority to Canadian patent application No. 3183328, filed on Dec. 2, 2022, the entire contents of which are incorporated herein by reference.

### TECHNICAL FIELD

The present disclosure relates to the field of vehicle battery swap, in particular to a single-sided movable battery swap station.

### BACKGROUND

At present, as requirements on vehicle emission are increasingly strict, automobile manufacturers start in the electric automobile market. However, an electric automobile still has a problem in terms of endurance supply. For the above-mentioned problem, there are two existing solutions, i.e., charging and swapping.

For charging, the problems in terms of charging piles and charging time need to be solved; moreover, in such a way, the problem of long-distance endurance cannot be solved, and the popularizing rate and number of the charging piles cannot satisfy the current huge increment of the number of electric automobiles to the great extent. However, a vehicle can be rapidly supplied with electric energy by battery swap; moreover, it is unnecessary for a user to consider the problem of aging caused by battery life. Therefore, it is required to focus on the consideration of layout and design of a battery swap station.

In the field of electric heavy trucks, there are three mainstream technical routes for battery swap, i.e., top-hoisting battery swap, overall single-sided battery swap and overall double-sided battery swap. The top-hoisting battery swap is the earliest commercialization solution; for such a battery swap way, a battery pack is hoisted by using a steel rope; the top-hoisting battery swap is simple in positioning way and higher in requirement on the driving skill of a driver; moreover, due to low automatic and intelligent levels in a battery swap process, the battery swap speed of such a battery swap station is limited, it is difficult to further increase the battery swap speed, a top-hoisting battery swap structure is relatively complex and fixed, and therefore, when some urban constructions are declared, the battery swap station in such a form may be determined as a temporary building of which the station construction examination and approval processes are complex. An overall single-sided battery swap station is high in battery swap speed, adaptable to various vehicles, such as muck trucks, tractors, and cement mixers, and high in development potential; however, there are higher requirements on the structural design of a battery swap mechanism as well as battery grabbing and positioning. For the overall double-sided battery swap, that is, each of two sides of a vehicle is provided with a set of battery swap mechanism, such a form has the greatest advantage that a battery does not take up the space of a packing case, and it is applicable to a mine truck on which the battery storage position is limited. However, its cost and occupied area are also relatively high.

Therefore, how to provide a single-sided movable battery swap station enabled to overcome the above-mentioned problem is a problem to be urgently solved by the skilled in the art.

### SUMMARY

In view of this, the present disclosure provides a single-sided movable battery swap station.

In order to achieve the above-mentioned purpose, the present disclosure adopts the following technical solution:
provided is a single-sided movable battery swap station, including:
a chassis, the chassis being rotatably connected with a plurality of wheels supporting the chassis, rotating shall axes of the plurality of wheels being capable of co-defining a reference surface, and one end of the chassis being connectable with a traction end of a tractor,
an equipment compartment, the equipment compartment being fixed above the chassis and being opened in one side, and a plurality of batteries being sequentially and equidistantly disposed in the equipment compartment along the length direction thereof; and
a battery swap assembly, the battery swap assembly comprising a rack, a sliding part, a first speed reducer, a gear, a second speed reducer, a first telescopic cylinder, a transverse telescopic part and a clamping part; the rack being fixed in the equipment compartment and being disposed above the batteries, and the length direction of the rack being the same as the length direction of the equipment compartment; the sliding part being slidably connected to the equipment compartment, and the sliding direction thereof being the same as the length direction of the rack; the first speed reducer being fixed with the sliding part, and an output shaft thereof being sleeved and fixedly provided with the gear; the gear being engaged with the rack; an output shaft of the second speed reducer and the first telescopic cylinder being both disposed to be perpendicular to the reference surface; two ends of the first telescopic cylinder being respectively fixed with the sliding part and the second speed reducer; the output shaft of the second speed reducer being connected to a fixed end of the transverse telescopic part, a telescopic end of the transverse telescopic part being fixed with a fixed end of the clamping part and being capable of extending out of the equipment compartment, and the telescopic direction of the telescopic end of the transverse telescopic part being parallel to the reference surface; and a clamping end of the clamping part being detachably connected to the batteries.

It is known from the above-mentioned technical solution that, compared with the prior art, the present disclosure provides a single-sided movable battery swap station. In the present disclosure, the wheels are mounted on the chassis, and therefore, the battery swap station can be towed by a tractor to move and can be flexibly disposed; the battery swap station is disposed on one side of a vehicle of which batteries are to be swapped, the transverse telescopic part in the battery swap assembly can move the batteries out of the equipment compartment, and meanwhile, batteries having no power on the vehicle of which the batteries are to be swapped can also be moved into the equipment compartment; the clamping part can reliably clamp the batteries; and the clamping part can move in the length direction of the equipment compartment and can also move in the telescopic direction of the transverse telescopic part, and meanwhile, the second speed reducer can drive the transverse telescopic part to rotate; and by such disposing, it can be ensured that the clamping part is adjustable in position and can be aligned with the batteries.

Preferably, comprising a plurality of lifting devices uniformly mounted below the chassis; each of the lifting devices comprising a sleeve, a second telescopic cylinder, an extension rod, a connecting rod, a third telescopic cylinder and a backing plate; one side wall of the sleeve and a side wall of the second telescopic cylinder being both fixed with the bottom of the chassis, the telescopic direction of the second telescopic cylinder being the same as the length direction of the sleeve, and the central line of the sleeve being parallel to the reference surface; the extension rod slidably penetrating in the sleeve; two ends of the connecting rod being respectively fixed with one end of the extension rod and a telescopic end of the second telescopic cylinder, the end, away from the connecting rod, of the extension rod being fixed with the third telescopic cylinder, the telescopic direction of the third telescopic cylinder being perpendicular to the reference surface, the third telescopic cylinder being disposed on the outer side of the chassis, the telescopic end thereof being fixed with an upper plate surface of the backing plate, and a lower plate surface of the backing plate being abuttable against the ground. The third telescopic cylinders in the lifting devices can lift the chassis, which aims at ensuring that the chassis is horizontally disposed and ensuring that the upper ends of the batteries are always disposed horizontally during battery swap.

Preferably, the battery swap assembly further comprises a first sliding rail, the rack and the first sliding rail are both fixed with the inner top wall of the equipment compartment, the length direction of the first sliding rail is the same as the length direction of the rack, a first sliding chute adapted to the first sliding rail is formed in the sliding part, and the first sliding rail is slidably embedded in the first sliding chute. The first sliding rail can limit the sliding part to ensure that the sliding part is reliably and slidably connected into the equipment compartment.

Preferably, the battery swap assembly further comprises a connecting disk, a limiting rod and a limiting tube, the end, away from the sliding part, of the first telescopic cylinder is fixed with an upper disk surface of the connecting disk, a body of the second speed reducer is fixed with a lower disk surface of the connecting disk, the limiting rod is perpendicularly fixed to the upper disk surface of the connecting disk, one end of the limiting tube is fixed with the sliding part, the end, away from the connecting disk, of the limiting rod is slidably inserted in the limiting tube, the sliding direction of the limiting rod is the same as the telescopic direction of the first telescopic cylinder, and the length of the limiting rod is less than the length of the limiting tube. The limiting rod and the limiting tube can improve the stability of the first telescopic cylinder during telescoping.

Preferably, the transverse telescopic part comprises a first strip-shaped plate, a second strip-shaped plate, a third strip-shaped plate, a first nut, second sliding rails, a connecting plate, a third speed reducer, a first screw, a second nut, limiting plates, a second screw and a fourth speed reducer; the first strip-shaped plate, the second strip-shaped plate and the third strip-shaped plate are sequentially disposed from top to bottom, and plate surfaces thereof are all parallel to the reference surface, and the length directions of the first strip-shaped plate, the second strip-shaped plate and the third strip-shaped plate are the same; the output shaft of the second speed reducer is perpendicularly fixed to an upper plate surface of the first strip-shaped plate, and a lower plate surface of the first strip-shaped plate is fixedly provided with the first nut and the second sliding rails; an upper plate surface of the second strip-shaped plate is fixedly provided with the connecting plate and the third speed reducer, second sliding chutes adapted to the second sliding rails are formed in the connecting plate, the second sliding rails are slidably embedded in the second sliding chutes, and the connecting plate and the third speed reducer are respectively disposed close to two ends of the second strip-shaped plate; one end of the first screw is rotatably connected to the connecting plate, the other end thereof is coaxially fixed with an output shaft of the third speed reducer, the length direction of the first screw is the same as the length direction of the second strip-shaped plate, and the first nut is screwed on the first screw; a lower plate surface of the second strip-shaped plate is fixedly provided with the second nut and the two limiting plates, the second nut is limited between the two limiting plates, the length directions of the limiting plates are the same as the length direction of the second strip-shaped plate, and a limiting through groove is formed in the plate surface of each of the limiting plates; two long sides of the third strip-shaped plate are respectively slidably embedded into the two limiting through grooves, a rectangular through hole is formed in a plate surface of the third strip-shaped plate, the second screw is rotatably connected to the third strip-shaped plate and is limited in the rectangular through hole, the second nut is screwed on the second screw, the length direction of the second screw is the same as the length direction of the third strip-shaped plate, the fourth speed reducer is fixed with the third strip-shaped plate and an output shaft thereof is coaxially fixed with the second screw, and the fixed end of the clamping part is fixed with a lower plate surface of the third strip-shaped plate. The transverse telescopic part can reliably achieve transverse telescoping and simple in structure and long in telescoping distance, and due to the driving of the third speed reducer and the fourth speed reducer, the telescoping distance of the transverse telescopic part is adjustable and easy to control.

Preferably, the clamping part comprises a plurality of vertical rods, a mounting plate, fifth speed reducers, a fourth telescopic cylinder, a baffle and a pressing plate; the plurality of vertical rods are perpendicularly and uniformly fixed on the lower plate surface of the third strip-shaped plate and are all limited between the two limiting plates, the mounting plate is disposed in parallel below the third strip-shaped plate and is fixed with the plurality of vertical rods, an upper plate surface of the mounting plate is fixedly provided with the fifth speed reducers and the fourth telescopic cylinder which are adjacently disposed, output shafts of the fifth speed reducers and the fourth telescopic cylinder are both disposed perpendicular to a plate surface of the mounting plate, the output shafts of the fifth speed reducers are perpendicularly fixed with the baffle after penetrating through the plate surface of the mounting plate, and an output shaft of the fourth telescopic cylinder is perpendicularly fixed with the pressing plate after penetrating through the plate surface of the mounting plate; the upper ends of the batteries are provided with two strip-shaped convex blocks disposed in parallel, the length directions of the strip-shaped convex blocks are perpendicular to the length direction of the rack, a clamping groove is formed in a long side wall of each of the strip-shaped convex blocks, and notches of the two clamping grooves are oppositely disposed; and the baffle is strip-shaped, the length of the baffle is greater than the shortest distance between the two strip-shaped convex blocks and is less than the distance between bottom walls of the two clamping grooves, the width of the baffle is less than the shortest distance between the two strip-shaped convex blocks, the thickness of the baffle is less than the width of each of the clamping grooves, and the plate surface on the side, away from the fourth telescopic cylinder, of the pressing plate is abuttable against the long side walls of the two strip-shaped convex blocks at the same time. Due to the combination of the upward movement of the baffle and the downward movement of the pressing plate, the baffle and the pressing plate can clamp and limit the strip-shaped convex blocks, the clamping pan can reliably clamp the batteries, and the batteries cannot shake during movement.

Preferably, comprising a controller, a distance measurement sensor and a laser scanner; the controller being fixed to the chassis; the distance measurement sensor and the laser scanner being both fixed to the lower plate surface of the mounting plate and being respectively disposed close to two ends of the mounting plate; the upper ends of the batteries being attached with identification codes identifiable for the laser scanner; and the controller being electrically connected to the first speed reducer, the second speed reducer, the first telescopic cylinder, the second telescopic cylinder, the third telescopic cylinder, the third speed reducer, the fourth speed reducer, the fifth speed reducers, the fourth telescopic cylinder and the distance measurement sensor respectively. By such disposing, it can be ensured that the first speed reducer, the first telescopic cylinder, the transverse telescopic part, the clamping part and the lifting devices can be reliably controlled; and by disposing the distance measurement sensor and the laser scanner, it is ensured that the clamping part can reliably align with the batteries.

### BRIEF DESCRIPTION OF DRAWINGS

FIG. 1 is a first overall axonometric diagram of a single-sided movable battery swap station;

FIG. 2 is a second overall axonometric diagram of the single-sided movable battery swap station;

FIG. 3 is a third overall axonometric diagram of the single-sided movable battery swap station;

FIG. 4 is a first partial axonometric diagram of the single-sided movable battery swap station;

FIG. 5 is a second partial axonometric diagram of the single-sided movable battery swap station;

FIG. 6 is a third partial axonometric diagram of the single-sided movable battery swap station;

FIG. 7 is a fourth partial axonometric diagram of the single-sided movable battery swap station;

FIG. 8 is a fifth partial axonometric diagram of the single-sided movable battery swap station;

FIG. 9 is a sixth partial axonometric diagram of the single-sided movable battery swap station;

FIG. 10 is a partial axonometric diagram shown after a transverse telescopic part in the single-sided movable battery swap station is partially unfolded; and

FIG. 11 is an overall axonometric diagram shown after the transverse telescopic part in the single-sided movable battery swap station is partially unfolded.

### DETAILED DESCRIPTION OF THE EMBODIMENTS

The present disclosure discloses a single-sided movable battery swap station. In the present disclosure, wheels 2 are mounted on a chassis 1, and therefore, the battery swap station can be towed by a tractor to move and can be flexibly disposed; the battery swap station is disposed on one side of a vehicle of which batteries are to be swapped, by disposing an equipment compartment 3 in which batteries 4 and a battery swap assembly can be reliably put, a transverse telescopic part in the battery swap assembly can move the batteries 4 out of the equipment compartment 3, and meanwhile, batteries having no power on the vehicle of which the batteries are to be swapped can also be moved into the equipment compartment; a clamping part can reliably clamp the batteries 4; and the clamping part can move in the length direction of the equipment compartment 3 and can also move in the telescopic direction of the transverse telescopic part, and meanwhile, a second speed reducer 9 can drive the transverse telescopic part to rotate; and by such disposing, it can be ensured that the clamping part is adjustable in position and can be aligned with the batteries 4; and by disposing lifting devices, the lifting devices can ensure that the chassis 1 is horizontally disposed when the battery swap station is used under the condition that the ground is uneven, and thus, reliable battery swap is guaranteed.

### Embodiment

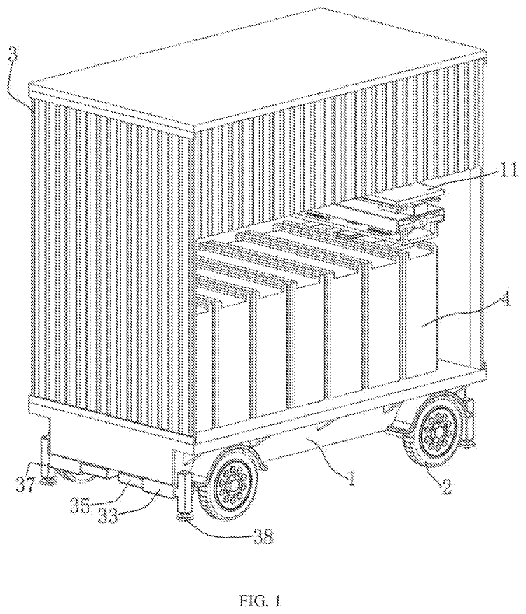

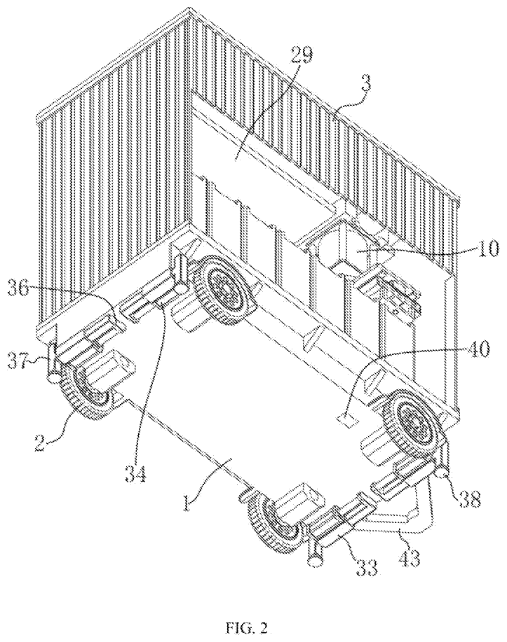

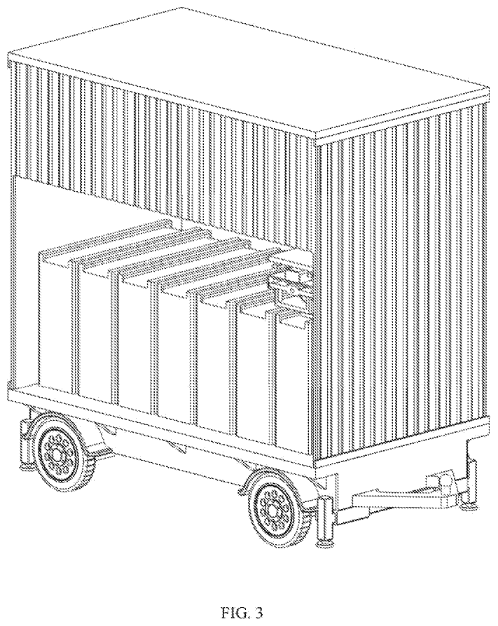

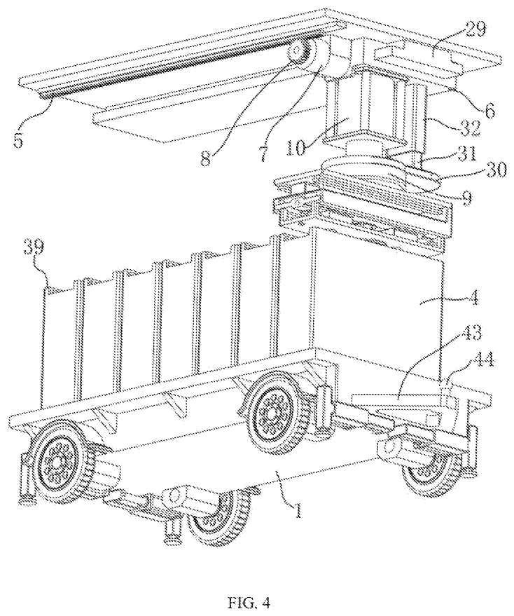

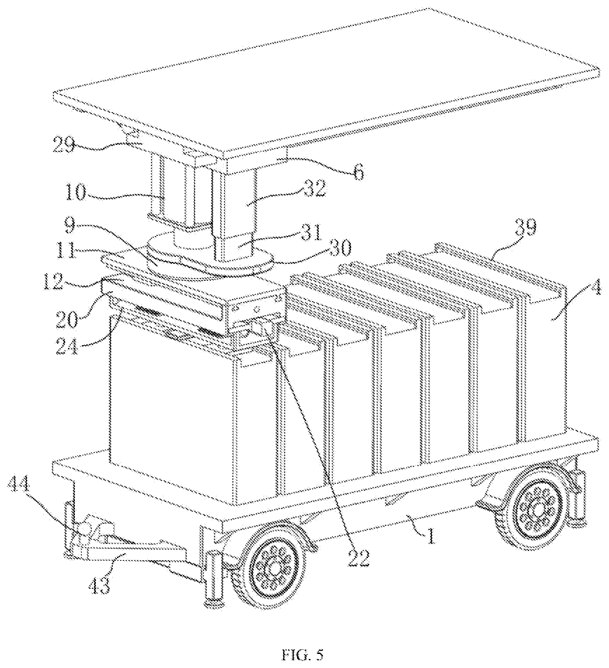

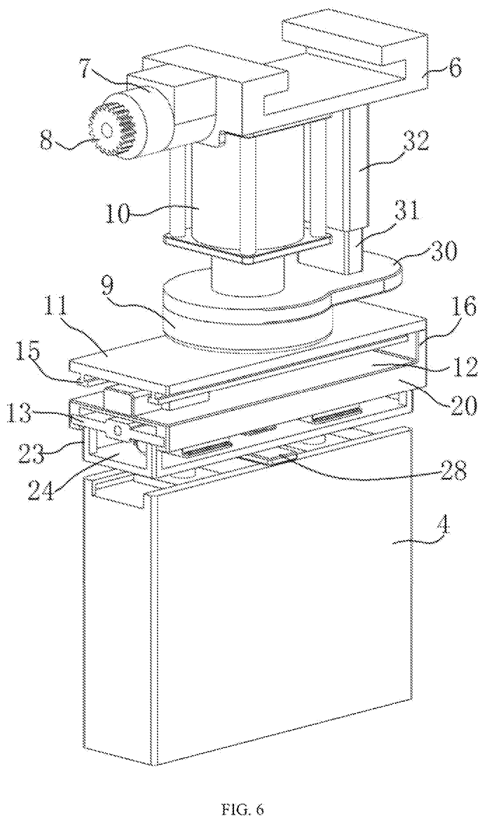

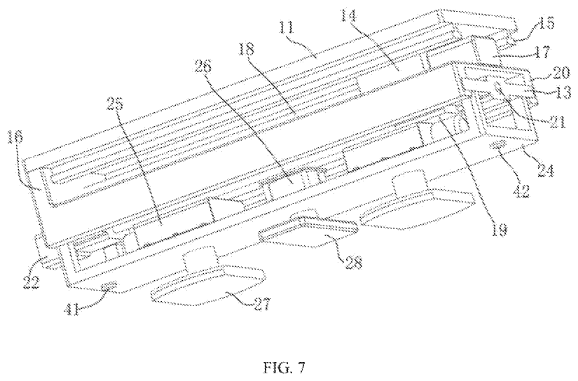

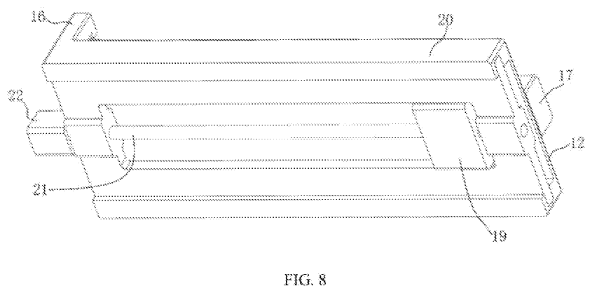

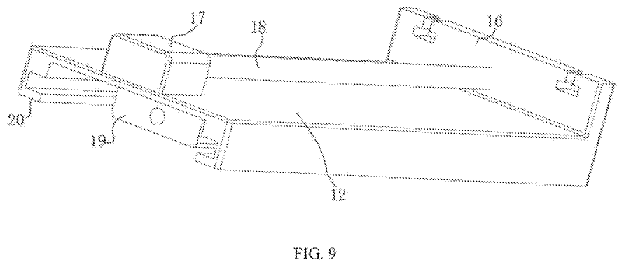

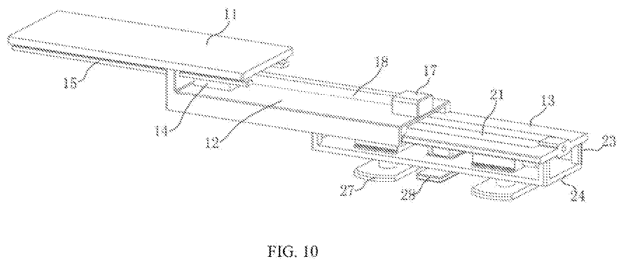

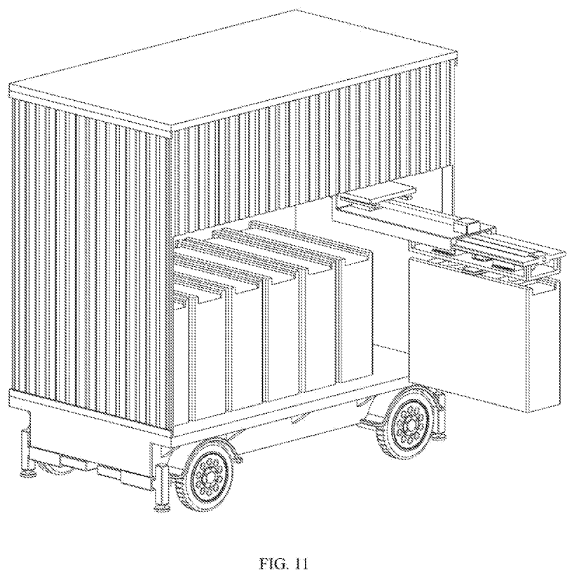

Referring to FIG. 1 to FIG. 11 which are schematic diagrams showing overall and partial structures in an implementation of the present disclosure, the present disclosure specifically discloses a single-sided movable battery swap station, including:
a chassis 1, wherein the chassis 1 is rotatably connected with four wheels 2 supporting the chassis 1, and the four wheels 2 is uniformly distributed on the four corners of the chassis 1;
under the condition that the positions of the chassis 1 and the wheels 2 are fixed or the chassis 1 is horizontally disposed, rotating shaft axes of the plurality of wheels 2 are capable of co-defining a reference surface; the positions of the chassis 1 and the wheels 2 are fixed, that is, the wheels 2 are not provided with vibration damping equipment, the positions of the rotating shaft axes of the wheels 2 and the chassis 1 are always unchanged under any road conditions; if the vibration damping equipment is mounted between the chassis 1 and each of the wheels 2, the shaft axes of the plurality of wheels 2 are coplanar when the chassis 1 is put on the horizontal ground, that is, the chassis 1 is horizontally put; and in the present embodiment, the positions of the chassis 1 and the wheels 2 are fixed;
one end of the chassis 1 is fixedly provided with a traction frame 43, the traction frame 43 is fixedly provided with a traction head 44, the traction head 44 is connected to a traction end of the tractor, and the tractor can tow the chassis 1 to advance;
an equipment compartment 3, wherein the equipment compartment 3 is a rectangular box, the length direction of the equipment compartment 3 is the same as the length direction of the chassis 1, the equipment compartment 3 is fixed above the chassis 1 and being opened in the long side, a door plate is detachably mounted at the opening of the equipment compartment 3, which aims at protecting equipment in the equipment compartment 3, and a plurality of rectangular fully-charged batteries 4 are sequentially and equidistantly disposed in the equipment compartment 3 along the length direction thereof. Herein, it should be noted that positions for putting undercharged batteries 4 are required to be reserved in the equipment compartment 3, that is, the equipment compartment 3 is required to be capable of holding batteries 4 which have been used and have no power;
during battery swap operation, the shortest distance between the equipment compartment 3 and the vehicle of which the batteries are to be swapped is greater than the length of each of the batteries 4;
in the present embodiment, bottom ends of the batteries 4 are provided with positioning holes and electric plug-in ports, the chassis 1 of the vehicle of which the batteries are to be swapped is provided with positioning pins and electric plugs which are matched with the positioning holes and the electric plug-in ports, the batteries 4 are vertically moved to achieve a mechanical and electric connection between each of the batteries 4 and the vehicle of which the batteries are to be swapped, that is, the positioning pins are inserted into the positioning holes, the electric plugs are inserted into the electric plug-in ports and are electrically conducted, meanwhile, the chassis 1 of the vehicle of which the batteries are to be swapped is further provided with buckles, the batteries 4 are provided with buckle slots, and after the above-mentioned positioning holes and the electric plug-in ports are mounted in place, the buckles can be buckled in the buckle slots, so that it is ensured that the batteries 4 can be stably put in an advance process of the vehicle.
a battery swap assembly, wherein the battery swap assembly includes a rack 5, a sliding part 6, a first speed reducer 7, a gear 8, a second speed reducer 9, a first telescopic cylinder 10, a transverse telescopic part and a clamping part;
the rack 5 is fixed in the equipment compartment 3 and is disposed above the batteries 4, the length direction of the rack 5 is the same as the length direction of the equipment compartment 3, the sliding part 6 is slidably connected to the equipment compartment 3, and the sliding direction thereof is the same as the length direction of the rack 5, the first speed reducer 7 is fixed with the sliding part 6, and an output shaft thereof is sleeved and fixedly provided with the gear 8, the gear 8 is engaged with the rack 5, and the first speed reducer 7 drives the gear 8 to rotate; the gear 8 is engaged with the rack 5, the sliding part 6 is slidably connected to the equipment compartment 3, and therefore, the sliding part 6 may also move along the length direction of the equipment compartment 3;
an output shaft of the second speed reducer 9 and the first telescopic cylinder 10 are both disposed to be perpendicular to the reference surface, two ends of the first telescopic cylinder 10 are respectively fixed with the sliding part 6 and the second speed reducer 9, and the output shaft of the second speed reducer is connected to a fixed end of the transverse telescopic part; the first telescopic cylinder 10 is disposed for the purpose of adjusting the height of the clamping part; and the second speed reducer 9 is disposed for the purpose of enabling the transverse telescopic part to be rotatable, and thus, the position of the clamping part is adjusted;
a telescopic end of the transverse telescopic part is fixed with a fixed end of the clamping part and is capable of extending out of the equipment compartment 3, the telescopic direction of the telescopic end of the transverse telescopic part is parallel to the reference surface, and a clamping end of the clamping part is detachably connected to the batteries 4, that is, the batteries 4 are clamped by the clamping part and are then horizontally moved out of the equipment compartment 3 by virtue of the transverse telescopic part; it should be noted that the batteries 4 can be disposed above the chassis 1 of the above-mentioned vehicle of which the batteries are to be swapped, and are not in contact with the positioning pins and the electric plugs when being horizontally moved out of the equipment compartment 3; and
lifting devices, wherein the lifting devices are uniformly mounted below the chassis 1, and the lifting devices are mainly used when the ground is uneven, which aims at ensuring that the reference surface is horizontally disposed;
each of the lifting devices includes a sleeve 33, a second telescopic cylinder 34, an extension rod 35, a connecting rod 36, a third telescopic cylinder 37 and a backing plate 38; the sleeve 33 is a rectangular tube, one side wall of the sleeve 33 and a side wall of the second telescopic cylinder 34 are both fixed with the bottom of the chassis 1, the length direction of the sleeve 33 is perpendicular to the length direction of the chassis 1, the telescopic direction of the second telescopic cylinder 34 is the same as the length direction of the sleeve 33, and the central line of the sleeve 33 is parallel to the reference surface; the extension rod 35 of which the section has a rectangular outer contour slidably penetrates in the sleeve 33; two ends of the connecting rod 36 are respectively fixed with one end of the extension rod 35 and a telescopic end of the second telescopic cylinder 34, the end, away from the connecting rod 36, of the extension rod 35 is fixed with the third telescopic cylinder 37, the telescopic direction of the third telescopic cylinder 37 is perpendicular to the reference surface, the third telescopic cylinder 37 is disposed on the outer side of the chassis 1, the telescopic end thereof is fixed with an upper plate surface of the backing plate 38, a lower plate surface of the backing plate 38 is abuttable against the ground, and the area of a plate surface of the backing plate 38 is greater than the area of an end surface of the telescopic end of the third telescopic cylinder 37, which aims at increasing the stressed area and ensuring that the lifting devices can reliably support the chassis 1.

Further, specifically, the battery swap assembly further includes a first sliding rail 29, the rack 5 and the first sliding rail 29 are both fixed with the inner top wall of the equipment compartment 3, the length direction of the first sliding rail 29 is the same as the length direction of the rack 5, the section of the first sliding rail 29 is inverted T-shaped, a first sliding chute adapted to the first sliding rail 29 in size and shape is formed in the sliding part 6, the first sliding rail 29 is slidably embedded in the first sliding chute. The sliding part 6 can be reliably limited on the inner top wall of the equipment compartment 3 while sliding.

Further, specifically, the battery swap assembly further includes a connecting disk 30, a limiting rod 31 and a limiting tube 32, the disk surface of the connecting disk 30 and the reference surface are located on the same horizontal plane, the fixed end of the first telescopic cylinder 10 is fixed with the sliding part 6, the telescopic end of the first telescopic cylinder 10 is fixed with the upper disk surface of the connecting disk 30, a body of the second speed reducer 9 is fixed with a lower disk surface of the connecting disk 30, the limiting rod 31 of which the section has a rectangular outer contour is perpendicularly fixed to the upper disk surface of the connecting disk 30, the limiting rod 31 and the first telescopic cylinder 10 are adjacently disposed, one end of the limiting tube 32 of which the section has a rectangular outer contour is fixed with the sliding part 6, the end, away from the connecting disk 30, of the limiting rod 31 is slidably inserted in the limiting tube 32, the sliding direction of the limiting rod 31 is the same as the telescopic direction of the first telescopic cylinder 10, and the length of the limiting rod 31 is less than the length of the limiting tube 32. Due to the design of the limiting rod 31 and the limiting tube 32, the stability of the first telescopic cylinder 10 during telescoping can be guaranteed.
the transverse telescopic part includes a first strip-shaped plate 11, a second strip-shaped plate 12, a third strip-shaped plate 13, a first nut 14, second sliding rails 15, a connecting plate 16, a third speed reducer 17, a first screw 18, a second nut 19, limiting plates 20, a second screw 21 and a fourth speed reducer 22;
sections of the first strip-shaped plate 11, the second strip-shaped plate 12 and the third strip-shaped plate 13 are all rectangular, the first strip-shaped plate 11, the second strip-shaped plate 12 and the third strip-shaped plate 13 are sequentially disposed from top to bottom, and plate surfaces thereof are all parallel to the reference surface, the length directions of the first strip-shaped plate 11, the second strip-shaped plate 12 and the third strip-shaped plate 13 are the same, and the length direction of the first strip-shaped plate 11 is perpendicular to the length direction of the chassis 1;
the output shaft of the second speed reducer 9 is perpendicularly fixed to an upper plate surface of the first strip-shaped plate 11, and a lower plate surface of the first strip-shaped plate 11 is fixedly provided with one rust nut 14 and two second sliding rails 15 of which the sections are inverted T-shaped, the first nut 14 is centered and limited between the two second sliding rails 15, and the length directions of the second sliding rails 15 are the same as the length direction of the first strip-shaped plate 11;
an upper plate surface of the second strip-shaped plate 12 is fixedly provided with the connecting plate 16 and the third speed reducer 17, a plate surface of the connecting plate 16 is perpendicular to a plate surface of the second strip-shaped plate 12, two second sliding chutes adapted to the second sliding rails 15 in both size and shape are formed in the connecting plate 16, the two second sliding rails 15 are respectively slidably embedded in the two second sliding chutes, and the connecting plate 16 and the third speed reducer 17 are respectively disposed close to two ends of the second strip-shaped plate 12;
one end of the first screw 18 is rotatably connected to the connecting plate 16, the other end thereof is coaxially fixed with an output shaft of the third speed reducer 17, the length direction of the first screw 18 is the same as the length direction of the second strip-shaped plate 12, and the first nut 14 is screwed on the first screw 18;
a lower plate surface of the second strip-shaped plate 12 is fixedly provided with the second nut 19 and the two limiting plates 20, the second nut 19 is centered and limited between the two limiting plates 20, the length directions of the limiting plates 20 are the same as the length direction of the second strip-shaped plate 12, a limiting through groove is formed in the plate surface of each of the limiting plates 20, and the length direction of the limiting through groove is the same as the length direction of the second strip-shaped plate 12;
two long sides of the third strip-shaped plate 13 are respectively slidably embedded into the two limiting through grooves, a rectangular through hole is formed in a plate surface of the third strip-shaped plate 13, the second screw 21 is rotatably connected to the third strip-shaped plate 13 and is limited in the rectangular through hole, the second nut 19 is limited in the rectangular through hole and is screwed on the second screw 21, the length direction of the second screw 21 is the same as the length direction of the third strip-shaped plate 13, the fourth speed reducer 22 is fixed with one end of the third strip-shaped plate 13, an output shaft of the fourth speed reducer 22 is coaxially fixed with the second screw 21, the third strip-shaped plate 13 is provided with a through hole for avoiding the output shaft of the fourth speed reducer 22, and the fixed end of the clamping part is fixed with a lower plate surface of the third strip-shaped plate 13.

The clamping part includes vertical rods 23, a mounting plate 24, fifth speed reducers 25, a fourth telescopic cylinder 26, a baffle 27 and a pressing plate 28; four vertical rods 23 are perpendicularly and uniformly fixed on the lower plate surface of the third strip-shaped plate 13 and are respectively disposed on the four corners of the mounting plate 24; the mounting plate 24 is a rectangular plate, and the length direction thereof is parallel to the length direction of the third strip-shaped plate 13; the four vertical rods 23 are all limited between the two limiting plates 20, the mounting plate 24 is disposed in parallel below the third strip-shaped plate 13, an upper plate surface of the mounting plate 24 is fixed with the lower ends of the four vertical rods 23 and is fixedly provided with the fifth speed reducers 25 and the fourth telescopic cylinder 26 which are adjacently disposed, there are two fifth speed reducers 25, the fourth telescopic cylinder 26 is centered between the two fifth speed reducers 25, output shafts of the fifth speed reducers 25 and the fourth telescopic cylinder 26 are both disposed perpendicular to a plate surface of the mounting plate 24, the output shafts of the fifth speed reducers 25 are perpendicularly fixed with the baffle 27 after penetrating through the plate surface of the mounting plate 24, the fifth speed reducers 25 can drive the baffle 27 to rotate for 90 DEG every time, and an output shaft of the fourth telescopic cylinder 26 is perpendicularly fixed with the pressing plate 28 after penetrating through the plate surface of the mounting plate 24;
the upper ends of the batteries 4 are provided with two strip-shaped convex blocks 39 disposed in parallel and having rectangular sections, the length directions of the strip-shaped convex blocks 39 are perpendicular to the length direction of the rack 5, a clamping groove is formed in a long side wall of each of the strip-shaped convex blocks 39, the length direction of the clamping groove is the same as the length direction of each of the strip-shaped convex blocks 39, and notches of the two clamping grooves are oppositely disposed;
the baffle 27 is strip-shaped, the length of the baffle 27 is greater than the shortest distance between the two strip-shaped convex blocks 39 and is less than the distance between bottom walls of the two clamping grooves, the width of the baffle 27 is less than the shortest distance between the two strip-shaped convex blocks 39, the thickness of the baffle 27 is less than the width of each of the clamping grooves, an upper plate surface of the baffle 27 is abuttable against the upper groove walls of the two clamping grooves at the same time, and the plate surface on the side, away from the fourth telescopic cylinder 26, of the pressing plate 28 is abuttable against the long side walls of the two strip-shaped convex blocks 39 at the same time; and
the baffle 27 is capable of rotating for 90 DEG every time so that two ends of the baffle 27 can be respectively embedded into or separated out of the two clamping grooves; and when the two ends of the baffle 27 are respectively embedded into the two clamping grooves, the pressing plate 28 downwards moves, the pressing plate 28 and the baffle 27 jointly clamp the strip-shaped convex blocks 39, and thus, the batteries 4 are clamped by the clamping part.

Further, specifically, a controller 40, a distance measurement sensor 41 and a laser scanner 42 are further included; the controller 40 is fixed to the chassis 1; the distance measurement sensor 41 and the laser scanner 42 are both fixed to the lower plate surface of the mounting plate 24 and are respectively disposed close to two ends of the mounting plate 24; and the upper ends of the batteries 4 are attached with identification codes identifiable for the laser scanner 42, the identification codes are centered between the two strip-shaped convex blocks 39, and in the present embodiment, the identification codes are bar codes or two-dimensional codes;

The laser scanner 42 and the identification codes are designed for the purposes of clamping and positioning of the clamping part and the batteries 4 and are beneficial for the clamping part to clamp or unclamp the batteries 4 later when the laser scanner 42 aligns with and identifies the identification codes;
the distance measurement sensor 41 is used for measuring the distance between the mounting plate 24 and the upper end of each of the batteries 4, the distance between the baffle 27 and the mounting plate 24 is fixed, and therefore, the distance between the baffle 27 and the upper end of each of the batteries 4 can be indirectly obtained by the distance measurement sensor 41, which aims at ensuring that the end of the baffle 27 can smoothly enter the clamping grooves when the baffle 27 rotates; and
when the laser scanner 42 aligns with and identifies the identification codes, and meanwhile, the proper distance between the baffle 27 and the upper end of each of the batteries 4 is measured by the distance measurement sensor 41, the mounting plate 24 align with the batteries 4 in position.

The controller 40 is electrically connected to the first speed reducer 7, the second speed reducer 9, the first telescopic cylinder 10, the second telescopic cylinder 34, the third telescopic cylinder 37, the third speed reducer 17, the fourth speed reducer 22, the fifth speed reducer 25, the fourth telescopic cylinder 26 and the distance measurement sensor 41 respectively. In the present embodiment, the controller 40 is provided with a wireless control module and further includes remote control equipment adapted thereto, and therefore, the operating personnel can control the battery swap station via the remote control equipment.

The battery swap station can be towed by a tractor to move and can be flexibly disposed:
in an initial state, the clamping part is disposed in the equipment compartment 3 and is located right above the batteries 4, the transverse telescopic part is in a completely retracted state and is also limited in the equipment compartment 3, and therefore, during battery swap operation:
step 1, the vehicle of which the batteries are to be swapped runs to the opened side of the equipment compartment 3, and it is ensured as much as possible that the vehicle of which the batteries are to be swapped is parallel to the equipment compartment 3, that is, the length directions of the undercharged batteries 4 on the vehicle of which the batteries are to be swapped are the same as the length directions of the fully-charged batteries 4 in the equipment compartment 3; at the same time, it is ensured that the chassis 1 is horizontally disposed, and the undercharged batteries 4 on the vehicle of which the batteries are to be swapped are also horizontally disposed;
step 2, the clamping part moves up and down for a certain distance, which aims at ensuring that the clamping part is higher than the undercharged batteries 4 on the vehicle of which the batteries are to be swapped; then, the transverse telescopic part drives the clamping part to extend out, the operating personnel perform observation by naked eyes and adjust the position of the clamping part by using the remote control equipment, and control the clamping part to clamp the undercharged batteries 4 after the clamping part aligns with the undercharged batteries in position;
step 3, the clamping part upwards moves so that the positioning pins are separated from the positioning holes, the electric plugs are separated from the electric plug-in ports, and then, the transverse telescopic part retracts for a certain distance, so that the undercharged batteries 4 are limited between the vehicle of which the batteries are to be swapped and the equipment compartment 3;
step 4, the sliding part 6 moves along the length direction of the equipment compartment 3 so that the undercharged batteries 4 align with vacant positions where no batteries 4 are put in the equipment compartment 4; and then, the transverse telescopic part retracts to reset, the clamping part is put downwards and also resets after ending the clamping for the undercharged batteries 4, and the undercharged batteries 4 are put in the equipment compartment 3;
step 5, the sliding part 6 moves along the length direction of the equipment compartment 3 so that the clamping part aligns with the fully-charged batteries 4 in the equipment compartment 3 in position; then, the clamping part downwards moves and clamps the fully-charged batteries 4, and after the clamping is ended, the transverse telescopic part extends out for a certain distance so that the fully-charged batteries 4 are limited between the vehicle of which the batteries are to be swapped and the equipment compartment 3; and
step 6, the sliding part 6 moves along the length direction of the equipment compartment 3 so that mounting positions of the fully-charged batteries 4 align with mounting positions of the batteries 4 of the vehicle of which the batteries are to be swapped, the transverse telescopic part further extends out for a certain distance, the operating personnel perform observation by naked eyes and adjust the position of the clamping part by using the remote control equipment, after the adjustment is ended, the clamping part downwards moves and ends the clamping for the fully-charged batteries 4, the fully-charged batteries 4 are successfully mounted on the vehicle of which the batteries are to be swapped, then, the clamping part upwards moves to reset, and the transverse telescopic part retracts to reset.

What is claimed is:

1. A single-sided movable battery swap station, comprising:
a chassis (1), the chassis (1) being rotatably connected with a plurality of wheels (2) supporting the chassis (1), rotating shaft axes of the plurality of wheels (2) being capable of co-defining a reference surface, and one end of the chassis (1) being connectable with a traction end of a tractor;
an equipment compartment (3), the equipment compartment (3) being fixed above the chassis (1) and being opened in one side, and a plurality of batteries (4) being sequentially and equidistantly disposed in the equipment compartment (3) along the length direction thereof; and
a battery swap assembly, the battery swap assembly comprising a rack (5), a sliding part (6), a first speed reducer (7), a gear (8), a second speed reducer (9), a first telescopic cylinder (10), a transverse telescopic part and a clamping part; the rack (5) being fixed in the equipment compartment (3) and being disposed above the batteries (4), and the length direction of the rack (5) being the same as the length direction of the equipment compartment (3); the sliding part (6) being slidably connected to the equipment compartment (3), and the sliding direction thereof being the same as the length direction of the rack (5); the first speed reducer (7) being fixed with the sliding part (6), and an output shaft thereof being sleeved and fixedly provided with the gear (8); the gear (8) being engaged with the rack (5); an output shaft of the second speed reducer (9) and the first telescopic cylinder (10) being both disposed to be perpendicular to the reference surface; two ends of the first telescopic cylinder (10) being respectively fixed with the sliding part (6) and the second speed reducer (9); the output shaft of the second speed reducer (9) being connected to a fixed end of the transverse telescopic part, a telescopic end of the transverse telescopic part being fixed with a fixed end of the clamping part and being capable of extending out of the equipment compartment (3), and the telescopic direction of the telescopic end of the transverse telescopic part being parallel to the reference surface; and a clamping end of the clamping part being detachably connected to the batteries (4).

2. The single-sided movable battery swap station according to claim 1, further comprising a plurality of lifting devices uniformly mounted below the chassis (1); each of the lifting devices comprising a sleeve (33), a second telescopic cylinder (34), an extension rod (35), a connecting rod (36), a third telescopic cylinder (37) and a backing plate (38); one side wall of the sleeve (33) and a side wall of the second telescopic cylinder (34) being both fixed with the bottom of the chassis (1), the telescopic direction of the second telescopic cylinder (34) being the same as the length direction of the sleeve (33), and the central line of the sleeve (33) being parallel to the reference surface; the extension rod (35) slidably penetrating in the sleeve (33); two ends of the connecting rod (36) being respectively fixed with one end of the extension rod (35) and a telescopic end of the second telescopic cylinder (34), the end, away from the connecting rod (36), of the extension rod (35) being fixed with the third telescopic cylinder (37), the telescopic direction of the third telescopic cylinder (37) being perpendicular to the reference surface, the third telescopic cylinder (37) being disposed on the outer side of the chassis (1), the telescopic end thereof being fixed with an upper plate surface of the backing plate (38), and a lower plate surface of the backing plate (38) being abuttable against the ground.

3. The single-sided movable battery swap station according to claim 1, wherein the battery swap assembly further comprises a first sliding rail (29), the rack (5) and the first sliding rail (29) are both fixed with the inner top wall of the equipment compartment (3), the length direction of the first sliding rail (29) is the same as the length direction of the rack (5), a first sliding chute adapted to the first sliding rail (29) is formed in the sliding part (6), and the first sliding rail (29) is slidably embedded in the first sliding chute.

4. The single-sided movable battery swap station according to claim 1, wherein the battery swap assembly further comprises a connecting disk (30), a limiting rod (31) and a limiting tube (32), the end, away from the sliding part (6), of the first telescopic cylinder (10) is fixed with an upper disk surface of the connecting disk (30), a body of the second speed reducer (9) is fixed with a lower disk surface of the connecting disk (30), the limiting rod (31) is perpendicularly fixed to the upper disk surface of the connecting disk (30), one end of the limiting tube (32) is fixed with the sliding part (6), the end, away from the connecting disk (30), of the limiting rod (31) is slidably inserted in the limiting tube (32), the sliding direction of the limiting rod (31) is the same as the telescopic direction of the first telescopic cylinder (10), and the length of the limiting rod (31) is less than the length of the limiting tube (32).

5. The single-sided movable battery swap station according to claim 2, wherein the transverse telescopic part comprises a first strip-shaped plate (11), a second strip-shaped plate (12), a third strip-shaped plate (13), a first nut (14), second sliding rails (15), a connecting plate (16), a third speed reducer (17), a first screw (18), a second nut (19), limiting plates (20), a second screw (21) and a fourth speed reducer (22); the first strip-shaped plate (11), the second strip-shaped plate (12) and the third strip-shaped plate (13) are sequentially disposed from top to bottom, and plate surfaces thereof are all parallel to the reference surface, and the length directions of the first strip-shaped plate (11), the second strip-shaped plate (12) and the third strip-shaped plate (13) are the same; the output shaft of the second speed reducer (9) is perpendicularly fixed to an upper plate surface of the first strip-shaped plate (11), and a lower plate surface of the first strip-shaped plate (11) is fixedly provided with the first nut (14) and the second sliding rails (15); an upper plate surface of the second strip-shaped plate (12) is fixedly provided with the connecting plate (16) and the third speed reducer (17), second sliding chutes adapted to the second sliding rails (15) are formed in the connecting plate (16), the second sliding rails (15) are slidably embedded in the second sliding chutes, and the connecting plate (16) and the third speed reducer (17) are respectively disposed close to two ends of the second strip-shaped plate (12); one end of the first screw (18) is rotatably connected to the connecting plate (16), the other end thereof is coaxially fixed with an output shaft of the third speed reducer (17), the length direction of the first screw (18) is the same as the length direction of the second strip-shaped plate (12), and the first nut (14) is screwed on the first screw (18); a lower plate surface of the second strip-shaped plate (12) is fixedly provided with the second nut (19) and the two limiting plates (20), the second nut (19) is limited between the two limiting plates (20), the length directions of the limiting plates (20) are the same as the length direction of the second strip-shaped plate (12), and a limiting through groove is formed in the plate surface of each of the limiting plates (20); two long sides of the third strip-shaped plate (13) are respectively slidably embedded into the two limiting through grooves, a rectangular through hole is formed in a plate surface of the third strip-shaped plate (13), the second screw (21) is rotatably connected to the third strip-shaped plate (13) and is limited in the rectangular through hole, the second nut (19) is screwed on the second screw (21), the length direction of the second screw (21) is the same as the length direction of the third strip-shaped plate (13), the fourth speed reducer (22) is fixed with the third strip-shaped plate (13) and an output shaft thereof is coaxially fixed with the second screw (21), and the fixed end of the clamping part is fixed with a lower plate surface of the third strip-shaped plate (13).

6. The single-sided movable battery swap station according to claim 5, wherein the clamping part comprises a plurality of vertical rods (23), a mounting plate (24), fifth speed reducers (25), a fourth telescopic cylinder (26), a baffle (27) and a pressing plate (28); the plurality of vertical rods (23) are perpendicularly and uniformly fixed on the lower plate surface of the third strip-shaped plate (13) and are all limited between the two limiting plates (20), the mounting plate (24) is disposed in parallel below the third strip-shaped plate (13) and is fixed with the plurality of vertical rods (23), an upper plate surface of the mounting plate (24) is fixedly provided with the fifth speed reducers (25) and the fourth telescopic cylinder (26) which are adjacently disposed, output shafts of the fifth speed reducers (25) and the fourth telescopic cylinder (26) are both disposed perpendicular to a plate surface of the mounting plate (24), the output shafts of the fifth speed reducers (25) are perpendicularly fixed with the baffle (27) after penetrating through the plate surface of the mounting plate (24), and an output shaft of the fourth telescopic cylinder (26) is perpendicularly fixed with the pressing plate (28) after penetrating through the plate surface of the mounting plate (24); the upper ends of the batteries (4) are provided with two strip-shaped convex blocks (39) disposed in parallel, the length directions of the strip-shaped convex blocks (39) are perpendicular to the length direction of the rack (5), a clamping groove is formed in a long side wall of each of the strip-shaped convex blocks (39), and notches of the two clamping grooves are oppositely disposed; and the baffle (27) is strip-shaped, the length of the baffle (27) is greater than the shortest distance between the two strip-shaped convex blocks (39) and is less than the distance between bottom walls of the two clamping grooves, the width of the baffle (27) is less than the shortest distance between the two strip-shaped convex blocks (39), the thickness of the baffle (27) is less than the width of each of the clamping grooves, and the plate surface on the side, away from the fourth telescopic cylinder (26), of the pressing plate (28) is abuttable against the long side walls of the two strip-shaped convex blocks (39) at the same time.

7. The single-sided movable battery swap station according to claim 6, further comprising a controller (40), a distance measurement sensor (41) and a laser scanner (42); the controller (40) being fixed to the chassis (1); the distance measurement sensor (41) and the laser scanner (42) being both fixed to the lower plate surface of the mounting plate (24) and being respectively disposed close to two ends of the mounting plate (24); the upper ends of the batteries (4) being attached with identification codes identifiable for the laser scanner (42); and the controller (40) being electrically connected to the first speed reducer (7), the second speed reducer (9), the first telescopic cylinder (10), the second telescopic cylinder (34), the third telescopic cylinder (37), the third speed reducer (17), the fourth speed reducer (22), the fifth speed reducers (25), the fourth telescopic cylinder (26) and the distance measurement sensor (41) respectively.
